(19) United States
(12) Patent Application Publication
(10) Pub. No.: US 2006/0038887 A1
(43) Pub. Date: Feb. 23, 2006

(54) Wireless LAN camera having digital signal boosting function and system processing module thereof

(76) Inventors: Kuang-Lei Chen, Hsinchu (TW); Chia-Cheng Yeh, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/098,463

(22) Filed: Apr. 5, 2005

(30) Foreign Application Priority Data
Aug. 20, 2004 (TW) 93213287

(51) Int. Cl. H04N 5/232

(52) U.S. Cl. 348/211.3

(57) ABSTRACT

A wireless LAN camera having digital signal boosting function and the system processing module thereof are proposed. The wireless LAN camera comprises a wireless LAN interface module, a system processing module, and an image sensor. The system processing module comprises a microprocessor connected to the wireless LAN interface module. The microprocessor manages scheduling and execution of all functional operations, and is used to modify parameters of an external package received by the wireless LAN interface module and then transfer it out via the wireless LAN interface module. An image processing interface connected to the microprocessor provides connection with the image sensor for processing an image signal inputted by the image sensor. The image signal is sent to the microprocessor for processing and then converted into an image package sent out via the wireless LAN interface module.

### FIELD OF THE INVENTION

The present invention relates to a wireless LAN camera having digital signal boosting function and, more particularly, to a wireless LAN camera integrating a wireless LAN device and a digital signal booster together.

### BACKGROUND OF THE INVENTION

Along with maturity of wired and wireless local area network (LAN) techniques, wireless LAN such as IEEE802.11a/b/g products are increasing. Various networks have gained higher and higher popularity. These WLAN/LAN products such as LAN cameras can get access to the Internet via LAN or WLAN. For example, they can get access to the Internet via wired access routers or wireless base stations/access points.

In general, in 802.11 communication systems, methods for detecting wireless LAN can be divided into active and passive. In an active detection method, a wireless LAN camera sends out a connection request to an access point (AP) and checks whether there is a response package. In a passive detection method, the wireless LAN camera doesn't send out any package but only analyze received 802.11 packages. In a wireless LAN, an AP will continually send out beacon packages containing information like service set identifier (SSID), support transmission rates, and medium access control (MAC) address of this AP. When the wireless LAN camera wants to achieve network connection, it will send out probe response package containing information like the SSID of the network domain it wants to enter and the transmission rate used based on received beacon packages.

In wireless communication environment, however, a wireless LAN camera usually can't intercommunicate with an AP or the quality of signal connection is bad because it is far away from the AP or is blocked from the AP by obstacles. In particular, for wireless devices responsible for safety works like wireless IP cameras, problems of inability to intercommunicate with the AP, weak signal, and obstruction from the AP will derive serious safety trouble.

In consideration of the above problems in the prior art, the present invention aims to propose a wireless LAN camera having digital signal boosting function. Through execution of software built in the wireless LAN camera, the digital signal boosting function can be accomplished for the wireless LAN camera.

### SUMMARY AND OBJECTS OF THE PRESENT INVENTION

An object of the present invention is to provide a wireless LAN camera having digital signal boosting function, which is a digital signal relay booster itself. Other wireless LAN cameras unable to make successful communication thus will achieve intercommunication using the wireless LAN camera having digital signal boosting function as an intermediary, hence accomplishing the effect of boosting digital signal.

Another object of the present invention is to provide a wireless LAN camera having digital signal boosting function, which is a digital signal booster itself.

It is unnecessary to add any signal booster, hence effectively lowering the installation cost of wireless LAN camera under the prerequisite of keeping good communication quality.

Another object of the present invention is to provide a wireless LAN camera having digital signal boosting function and the system processing module thereof, which can perform package transfer actions to make the wireless LAN camera a digital signal booster itself.

According to the present invention, in a wireless communication network having several wireless LAN cameras and at least an AP, a wireless LAN camera having better communication quality is first selected as a transfer device according to the communication status between these wireless LAN cameras and the AP. After the selected wireless LAN camera receives a management package from the AP, it will directly transfer the management package or modify management parameters of the management package for transferring a management-like package containing management-like parameters out. When another wireless LAN camera wants to make wireless LAN message communication, it will perform transceiving of package with the AP via the transfer device.

The above wireless LAN camera having digital signal boosting function comprises a wireless LAN interface module, a system processing module, and an image sensor. The system processing module comprises a microprocessor and an image processing module. The microprocessor is connected with a wireless LAN interface module, manages scheduling and execution of all functional operations, and is used to modify parameters of an external package received by the wireless LAN interface module and then transfer it out via the wireless LAN interface module. The image processing interface is connected with the microprocessor and the image sensor and used to process an image signal inputted by the image sensor, send the processed image signal to the microprocessor for processing, and then convert the image signal into an image package sent out via the wireless LAN interface module.

The various objects and advantages of the present invention will be more readily understood from the following detailed description when read in conjunction with the appended drawings, in which:

### BRIEF DESCRIPTION OF DRAWING

FIG. 1 is a diagram of a wireless LAN architecture used in the present invention;

FIG. 2 is a signal transmission diagram of a digital signal boosting method of the present invention used in a network architecture; and

FIG. 3 is a structure block diagram of a wireless LAN camera and the system processing module thereof according to an embodiment of the present invention.

### DETAILED DESCRIPTION OF PREFERRED EMBODIMENT

The present invention makes use of a wireless LAN camera having digital signal boosting function as an intermediary so that wireless LAN cameras unable to communicate with access point (AP) because of being at faraway locations or isolation by obstacles can accomplish intercommunication.

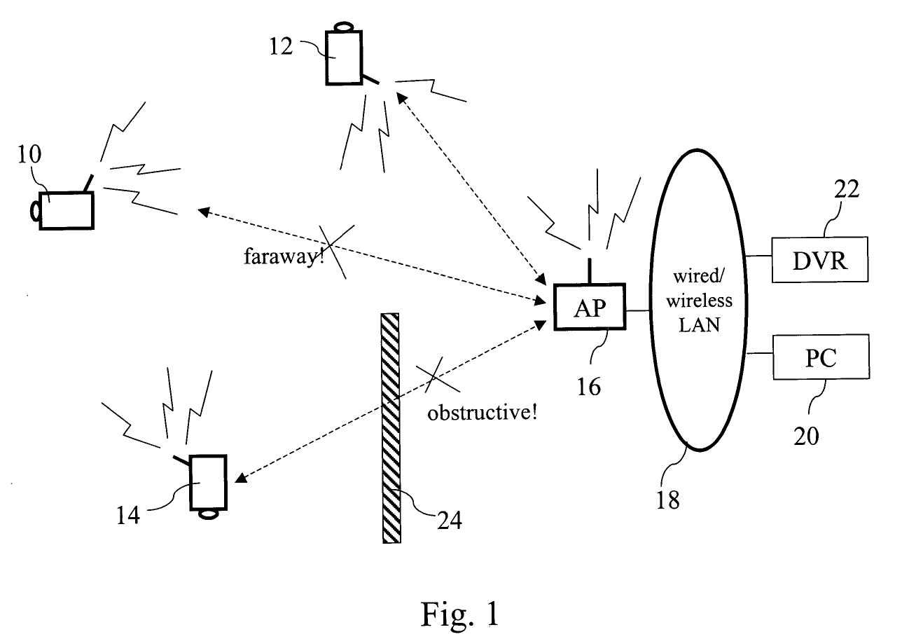

In a wireless LAN, several wireless LAN cameras usually get access to the Internet via an access point (AP). As shown in FIG. 1, three wireless LAN cameras 10, 12, and 14 perform message communication with an AP in a wireless way. They get access to a wired/wireless LAN 18 via the AP 16 and then to a remote computer 20 and a digital video recorder (DVR) 22 via the wired/wireless LAN 18. The distance between the first wireless LAN camera 10 and the AP 16 is too large, hence causing serious attenuation of signal. There is an obstacle 24 between the third wireless LAN camera 14 and the AP 16 so that they can't intercommunicate. The second wireless LAN camera 12 is close to the AP 16 and there is no obstacle between them so that the communication strength is good.

In order to let the first and third wireless LAN cameras 10 and 14 successfully perform message communication with the AP 16 to get access to the wired/wireless LAN 18, the digital signal boosting method of wireless LAN camera of the present invention comprises the following steps. First, the second wireless LAN camera 12 having better communication quality is selected as a transfer device based on the communication status between these wireless LAN cameras 10, 12, and 14 and the AP 16. A software is installed in the second wireless LAN camera 12 so that the second wireless LAN camera 12 can simulate the behavior of the AP 16 for performing package transfer actions.

Once the transfer mechanism of the second wireless LAN camera 12 is activated, after the second wireless LAN camera 12 receives a management package from the AP, it will directly transfer the management package or modify management parameters of the management package for transferring a management-like package containing management-like parameters. The modified management parameters usually contain identification data like service set identifier (SSID), network domain address, or authentication code. When the first and third wireless LAN cameras 10 and 14 want to make wireless LAN message communication, they will perform transceiving of package with the AP 16 via the second wireless LAN camera 12.

The detailed procedures of how the first and third wireless LAN cameras 10 and 14 perform package transmission with the AP 16 via the second wireless LAN camera 12 are described below. Package transmission of the first wireless LAN camera 10 will be exemplified below. After the first wireless LAN camera 10 receives the management-like package from the second wireless LAN camera 12, the first wireless LAN camera 10 will take the second wireless LAN camera 12 as another AP and send a network package to the second wireless LAN camera 12 because the management-like package contains information of management-like parameters. The network package also contains information corresponding to the management-like parameters. The second wireless LAN camera 12 performs package processing after receiving the network package to restore the management-like parameters back to the management parameters corresponding to the AP 16. Next, after the second wireless LAN camera 12 receives network packages from the AP again, it will process these network packages and modify their management parameters into management-like parameters. After reserving messages corresponding to itself, the second wireless LAN camera 12 will transfer messages not corresponding to itself and the management-like parameters together to the first wireless LAN camera 10. Similarly, the procedure of how the third wireless LAN camera 14 communicate with the AP 16 via the second wireless LAN camera 12 are the same as stated above.

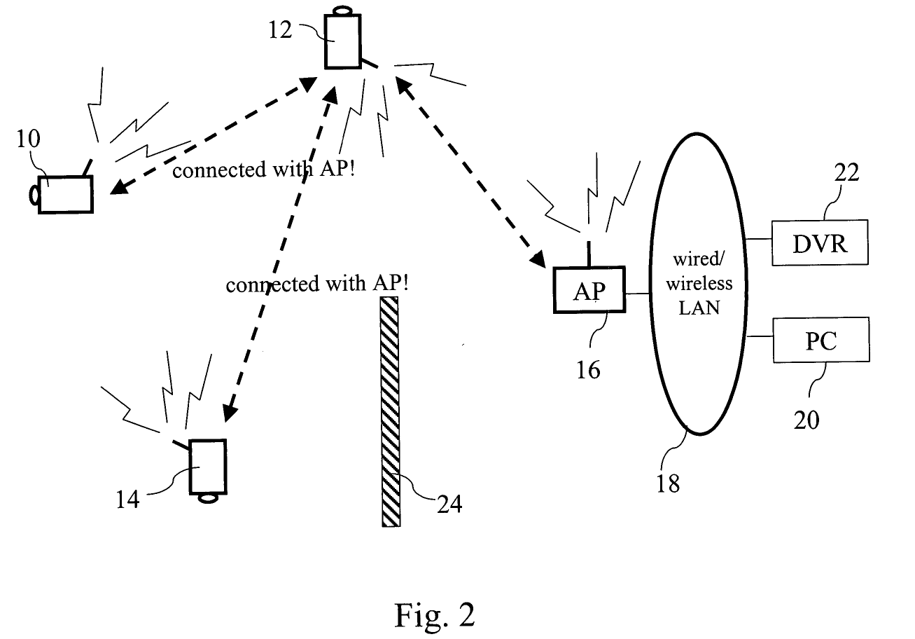

In this way, these wireless LAN cameras 10, 12, and 14 continually repeat the above package transfer actions, as shown in FIG. 2. In addition to playing the role of a monitor camera, the second wireless LAN camera 12 is also a digital signal booster so that the first wireless LAN camera 10 at a faraway location and the third wireless LAN camera 14 whose signals are obstructed can transmit video signals to the remote DVR 22 or computer 20 in a relay way through the second wireless LAN camera 12. Similarly, the remote DVR 22 or computer 20 can control the remote wireless LAN cameras 10, 12, and 14 in this relay way.

Whether the transfer action of the second wireless LAN camera 12 is activated can be set artificially. After the software of the above method is installed in the second wireless LAN camera 12, the user can determine whether to activate the transfer actions of the second wireless LAN camera 12 based on the reception situation of the other wireless LAN cameras 10 and 14.

Besides, the second wireless LAN camera 12 used as a transfer device transfers management-like packages instead of directly sending out management packages during the transfer process after modifying the management parameters of the AP 16. Therefore, the first and third wireless LAN cameras 10 and 12 unable to receive signals of the AP 16 will receive the management-like packages. If there is another wireless LAN camera such as a fourth wireless LAN camera having good communication strength with the AP 16, because the second wireless LAN camera 12 sends out management-like packages instead of management packages, the fourth wireless LAN camera will directly perform package transmission with the AP 16 rather than performing transfer actions via the second wireless LAN camera 12. The present invention thus can prevent wireless LAN cameras capable of directly communicating with the AP 16 from taking the second wireless LAN camera 12 as the actual AP 16, hence avoiding the occurrence of erroneous actions. Moreover, the message transmission speed of wireless LAN cameras capable of directly communicating with the AP 16 can be maintained.

The digital signal boosting method of the present invention makes a wireless LAN camera a digital signal booster also so that wireless LAN cameras unable to communicate because of being at faraway locations or isolation by obstacles can accomplish intercommunication using a wireless LAN camera having digital signal boosting function as the intermediary. The present invention can solve the problem of weak signal or blockage of signal of conventional wireless LAN cameras to accomplish the digital signal boosting function. Moreover, it is not necessary to add any booster. Therefore, under the prerequisite of keeping good communication quality, the cost of boosting digital signal can be effectively lowered.

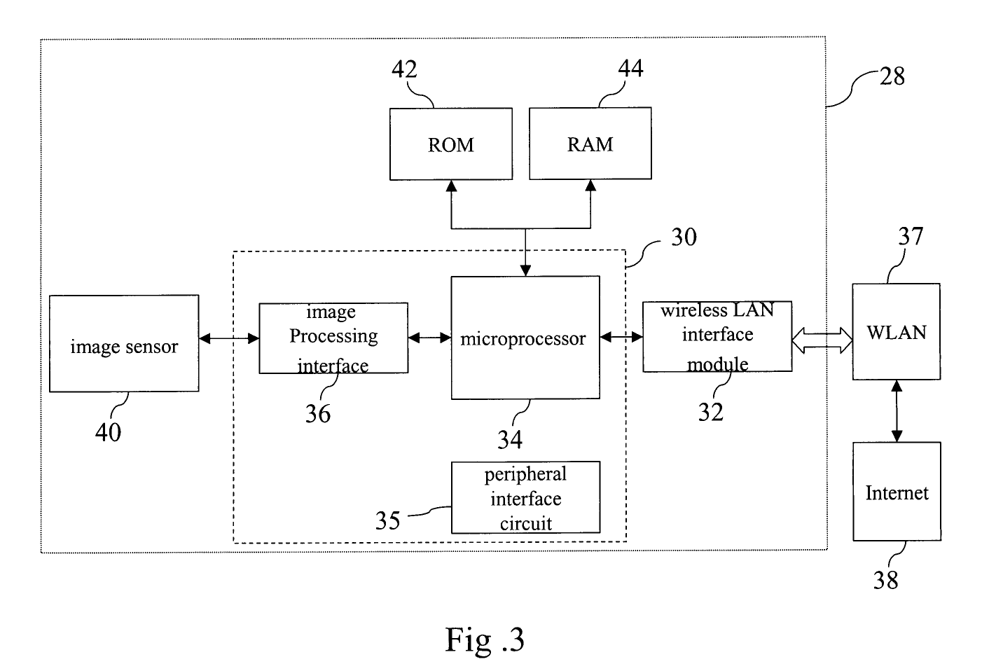

As shown in FIG. 3, a wireless LAN camera 28 having digital signal boosting function comprises a system processing module 30, an image sensor 40, and a wireless LAN interface module 32. The system processing module 30 comprises a microprocessor 34, an image processing interface 36, and a peripheral interface circuit 35. The wireless LAN interface module 34 provides connection with a wireless LAN 37. The wireless LAN 37 is made use of for connecting the Internet 38 so that a package can be sent out or an external package can be received through the wireless LAN 37 and the Internet 38. The microprocessor 34 connects the wireless LAN interface module 32, manages scheduling and execution of all functional operations, commands action procedures of all peripherals, and is used to modify parameters of the external package and then transfer it out via the wireless LAN interface module 32. The image processing interface 36 connects the microprocessor 34 and provides connection with the image sensor 40. An encoding circuit is disposed in the image processing interface 36, which receives an image signal from the image sensor 40 and then compresses the image signal into a JPEG, Motion-JPEG, MPEG1, or MPEG4 file and stores the file in an RAM 44. Next, the microprocessor 34 processes the image signal into an image package sent out via the wireless LAN interface module 32. The image sensor 40 connected with the image processing interface 36 is usually a charge coupled device (CCD) or a complementary metal oxide semiconductor (CMOS) for sending an image. The peripheral interface circuit 35 is usually an RS-232, USB port, or another I/O interface.

The microprocessor 34 also connects a memory device containing a ROM 42 and a RAM 44. The ROM 42 can be a flash memory or other nonvolatile memory. Application programs like operation systems, network protocols, audio/video (A/V) control programs, I/O control programs, and transfer programs are installed in the ROM 42 so that the microprocessor 34 can perform corresponding works according to these application programs. In this embodiment, the two memories 42 and 44 and the system processing module 30 belong to different chips or circuits. Of course, the two memories 42 and 44 and the system processing module 30 can be integrated into the same chip or circuit to become a system-on-chip (SOC).

The above system processing module 30 is installed in a wireless LAN camera 28, which not only has image capturing and processing functions but also has the above package transfer function, hence accomplishing the object of boosting digital signal.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A wireless LAN camera having digital signal boosting function comprising:
a wireless LAN interface module providing connection to the Internet and used to send a package and receive an external package via the Internet;
a system processing module connected with said wireless LAN interface module and managing scheduling and execution of all functional operations and used to modify parameters of said external package and then transfer it out via said wireless LAN interface module; and
an image sensor connected with said system processing module for image sensing and used to send an image signal to said system processing module for processing and then convert said image signal into an image package sent out via said wireless LAN interface module.

2. The wireless LAN camera as claimed in claim 1, wherein said system processing module comprises:
at least a memory device for storage of data and programs;
a microprocessor connected with said memory device and managing scheduling and execution of all functional operations and used to modify parameters of said external package and then transfer it out via said wireless LAN interface module;
an image processing interface connected with said microprocessor and used to process said image signal inputted by said image sensor, send the processed image signal to said microprocessor for processing, and then convert said image signal into an image package sent out via said wireless LAN interface module; and
a peripheral interface circuit connected with said microprocessor and providing signal connection with peripherals.

3. The wireless LAN camera as claimed in claim 2, wherein at least one of the group composed of operation system, network protocol, A/V control program, I/O control program, and transfer program is built in said memory device.

4. The wireless LAN camera as claimed in claim 2, wherein said memory device is selected from at least one of the group composed of ROM and RAM.

5. The wireless LAN camera as claimed in claim 4, wherein said ROM is a nonvolatile memory.

6. The wireless LAN camera as claimed in claim 2, wherein an encoding circuit is disposed in said image processing interface, and said encoding circuit is used to receive said image signal inputted by said image sensor and compress said image signal and then transfer it to said microprocessor.

7. The wireless LAN camera as claimed in claim 6, wherein the file format of the compressed image signal is selected from one of JPEG, Motion-JPEG, MPEG1, and MPEG4.

8. A system processing module of a wireless LAN camera having digital signal boosting function comprising:
at least a memory device for storage of data and programs;
a microprocessor connected with said memory device and managing scheduling and execution of all functional operations and used to modify parameters of said external package and then transfer it out;
an image processing interface connected with said microprocessor and providing connection with an image sensor for processing an image signal inputted by said image sensor and sending the processed image signal to said microprocessor for processing; and
a peripheral interface circuit connected with said microprocessor and providing signal connection with peripherals.

9. The system processing module of a wireless LAN camera having digital signal boosting function as claimed in claim 8, wherein at least one of the group composed of operation system, network protocol, A/V control program, I/O control program, and transfer program is built in said memory device.

10. The system processing module of a wireless LAN camera having digital signal boosting function as claimed in claim 8, wherein said memory device is selected from at least one of the group composed of ROM and RAM.

11. The system processing module of a wireless LAN camera having digital signal boosting function as claimed in claim 10, wherein said ROM is a nonvolatile memory.

12. The system processing module of a wireless LAN camera having digital signal boosting function as claimed in claim 8, wherein an encoding circuit is disposed in said image processing interface, and said encoding circuit is used to receive said image signal inputted by said image sensor and compress said image signal and then transfer it to said microprocessor.

13. The system processing module of a wireless LAN camera having digital signal boosting function as claimed in claim 12, wherein the file format of the compressed image signal is selected from one of JPEG, Motion-JPEG, MPEG1, and MPEG4.
